(19) United States
(12) Patent Application Publication
(10) Pub. No.: US 2026/0050171 A1
(43) Pub. Date: Feb. 19, 2026

(54) HEAD-MOUNTED DISPLAY DEVICE

(71) Applicant: Beijing Zitiao Network Technology Co., Ltd., Beijing (CN)

(72) Inventors: Tao SUN, Beijing (CN); Yingjie LI, Beijing (CN); Yi LAI, Beijing (CN)

(21) Appl. No.: 19/251,311

(22) Filed: Jun. 26, 2025

(30) Foreign Application Priority Data
Aug. 15, 2024 (CN) 202411125592.X

(51) Int. Cl. G02B 27/01

(52) U.S. Cl. CPC G02B 27/0176; G02B 27/0172; G02B 2027/0138; G02B 2027/015; G02B 2027/0152; G02B 2027/0161

(57) ABSTRACT

A head-mounted display device is provided, which includes: a housing; a main circuit board; at least two camera components; at least two flexible connecting members respectively connected in correspondence with the at least two camera components; the main circuit board and the at least two camera components are provided in the housing; each camera component is electrically connected to the main circuit board through a corresponding flexible connecting member; at least two layers of the flexible connecting members are stacked and insulated from each other; the at least two flexible connecting members are in a bent state.

### CROSS-REFERENCE TO RELATED APPLICATION

This application claims the priority to and benefits of the Chinese Patent Application, No. 202411125592.X, which was filed on Aug. 15, 2024, and is hereby incorporated by reference in its entirety.

### TECHNICAL FIELD

The present disclosure relates to the technical field of virtual reality, and particularly to a head-mounted display device.

### BACKGROUND

Virtual Reality (VR) technology, also known as spiritual realm technology, includes computer, electronic information, and simulation technology. Its basic implementation method is to simulate the virtual environment by computer to give people a sense of environmental immersion. With the continuous development of social productivity and science and technology, the demand for VR technology in all walks of life is increasingly strong, and VR technology has also made significant progress and gradually become a new field of science and technology.

When a head-mounted display device having a plurality of camera components is assembled, the connector device between the plurality of camera components and the main circuit board needs to occupy a large mounting space, resulting in excessive volume of the entire head-mounted display device and poor user experience.

### SUMMARY

In order to solve the above technical problems, the present disclosure provides a head-mounted display device, which can effectively save mounting space and reduce the volume of the whole machine.

At least an embodiment of the present disclosure provides a head-mounted display device, which includes:
a housing;
a main circuit board;
at least two camera components;
at least two flexible connecting members respectively connected in correspondence with the at least two camera components;
where the main circuit board and the at least two camera components are provided in the housing;
each camera component is electrically connected to the main circuit board through a corresponding flexible connecting member;
at least two of the flexible connecting members are stacked and insulated from each other;
the at least two flexible connecting members are in a bent state.

As an optional technical solution, the at least two camera components further include two RGB camera components and one TOF camera component, and a flexible connecting member to which the TOF camera component is connected and a flexible connecting member to which one of the RGB camera components is connected are stacked and insulated from each other.

As an optional technical solution, the head-mounted display device further includes an indicator light, where the indicator light is connected to the flexible connecting member corresponding to the TOF camera component.

As an optional technical solution, the head-mounted display device further includes a display screen, where the main circuit board is electrically connected with a capacitor, the central axis of the capacitor is parallel to the main circuit board, and the capacitor is connected to the display screen through the main circuit board.

As an optional technical solution, the main circuit board is provided with an elastic piece, the capacitor is electrically connected and mounted on a first FPC flexible board, and the first FPC flexible board is fixedly connected to the elastic piece and electrically connected to the main circuit board through the elastic piece.

As an optional technical solution, a length of the first FPC flexible board in a direction perpendicular to the main circuit board is smaller than a length of the capacitor in a direction along a central axis of the capacitor.

As an optional technical solution, the first FPC flexible board includes a connecting portion, the connecting portion is provided parallel to the main circuit board, and the connecting portion is fixedly connected to the elastic piece.

As an optional technical solution, the camera component and the flexible connecting member are connected through a plug-in interface; and/or
the main circuit board and the flexible connecting member are connected by a plug-in interface.

As an optional technical solution, the housing includes a front housing, a middle housing, and a rear housing connected in sequence, the camera component is mounted on the front housing, and the main circuit board is mounted on the middle housing.

As an optional technical solution, one end of the front housing is rotatably connected to the middle housing, and another end of the front housing is snapped into the middle housing.

### BRIEF DESCRIPTION OF DRAWINGS

The accompanying drawings herein, which are incorporated into and constitute a part of the specification, illustrate embodiments consistent with the present disclosure and, together with the specification, serve to explain the principles of the present disclosure.

In order to more clearly explain the technical solutions in the embodiments of the present disclosure, the drawings that need to be used in the description of the embodiments will be briefly introduced below, and it is obvious that other drawings can be obtained from these drawings without making creative labor for those skilled in the art.

FIG. 1 is a schematic diagram of the exterior of a head-mounted display device according to an embodiment of the present disclosure.

FIG. 2 is a schematic diagram of the internal structure of a head-mounted display device according to an embodiment of the present disclosure.

FIG. 3 is a schematic structural diagram of a head-mounted display device after hiding the housing according to an embodiment of the present disclosure;

FIG. 4 is a schematic diagram of a head-mounted display device when a front housing is in an open state according to an embodiment of the present disclosure;

FIG. 5 is a schematic structural diagram of a camera component of a head-mounted display device provided in a front housing according to an embodiment of the present disclosure;

FIG. 6 is a schematic diagram of an arrangement of flexible connecting members of the head-mounted display device according to an embodiment of the present disclosure.

FIG. 7 is an enlarged schematic diagram at place A of FIG. 6 according to an embodiment of the present disclosure;

FIG. 8 is a schematic structural diagram of a main circuit board of a head-mounted display device according to an embodiment of the present disclosure.

FIG. 9 is a schematic diagram showing a capacitor of a head-mounted display device mounted on a main circuit board according to an embodiment of the present disclosure;

FIG. 10 is a schematic diagram of assembling a capacitor of a head-mounted display device and a first FPC flexible board according to an embodiment of the present disclosure.

Where,
1, housing; 11, front housing; 111, buckle; 112, rib; 12, middle housing; 2, main circuit board; 21, second female connector; 22, elastic piece; 3, camera component; 31, first female connector; 32, RGB camera component; 33, TOF camera component; 4, flexible connecting member; 41, first male connector; 42, second male connector; 5, indicator light; 6, capacitor; 7, first FPC flexible board; 71, connecting portion.

### DETAILED DESCRIPTION

In order to enable a clearer understanding of the above-described objects, features, and advantages of the present disclosure, the embodiments of the present disclosure will be further described below. It should be noted that the embodiments of the present disclosure and the features in the embodiments may be combined with each other as long as there is no conflict.

Numerous specific details are set forth in the following description to facilitate a full understanding of the disclosure, but the disclosure may be practiced in other ways than those described herein; obviously, the embodiments in the specification are only a part of the embodiments of the present disclosure, but not all the embodiments.

With the rapid development of VR technology, head-mounted display device is increasingly favored by users. At present, when the head-mounted display device with a plurality of camera components is assembled, the connector device between the plurality of camera components and the main circuit board needs to occupy a large space, resulting in excessive volume of the entire head-mounted display device and poor user experience.

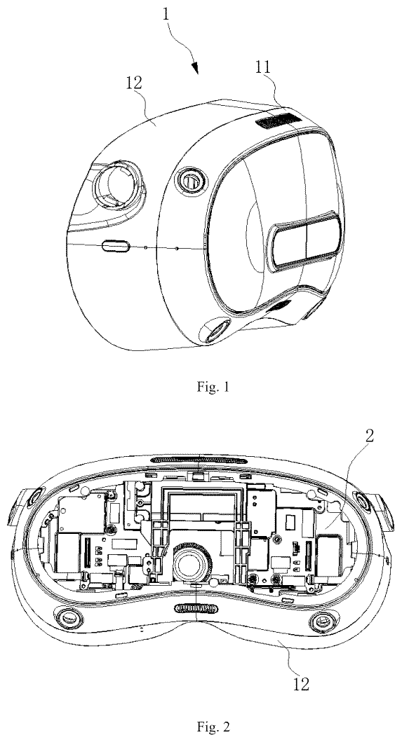

In order to solve the above problems, an embodiment of the present disclosure provides a head-mounted display device, which can be referred to in FIG. 1 to FIG. 3. The head-mounted display device includes a housing 1, a main circuit board 2, a camera component 3, and a flexible connecting member 4, and the main circuit board 2, the camera component 3, and the flexible connecting member 4 are all provided in the housing 1 to realize VR imaging. Where:
the housing 1 includes a front housing 11, a middle housing 12, and a rear housing (not shown in the drawing) which are connected in sequence, and the front housing 11, the middle housing 12, and the rear housing may be fixedly connected by using a buckle to snap together, or may be connected by a connecting member such as a screw. In the present embodiment, as shown in FIG. 4, one end of the front housing 11 is rotatably connected to the middle housing 12, and another end of the front housing 11 is snapped to the middle housing 12 by a buckle 111. For example, buckles 111 may be provided on both sides of the front housing 11, and when the front housing 11 snaps-fit to the middle housing 12, the front housing 11 is further snapped to the middle housing 12 by the buckles 111 on both sides.

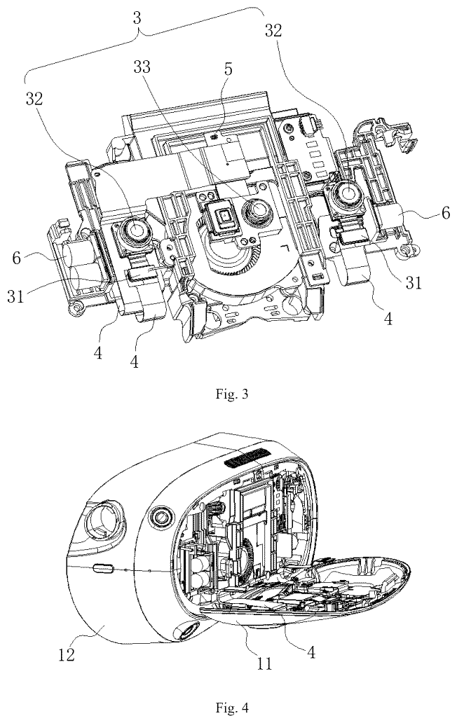

In the embodiment of the present disclosure, at least two camera components 3 are provided, and the at least two camera components 3 are both mounted in the front housing 11, and head-mounted display device imaging is realized by the camera components 3. Optionally, the at least two camera components 3 include two RGB camera components 32 and one TOF camera component 33, where the RGB camera component 32 is used for collecting image information, and the TOF camera component 33 is used for collecting depth data. As shown in FIG. 3, the two RGB camera components 32 of the present embodiment are respectively provided on the left and right sides of the front housing 11, and the TOF camera component 33 is located at the middle portion of the front housing 11.

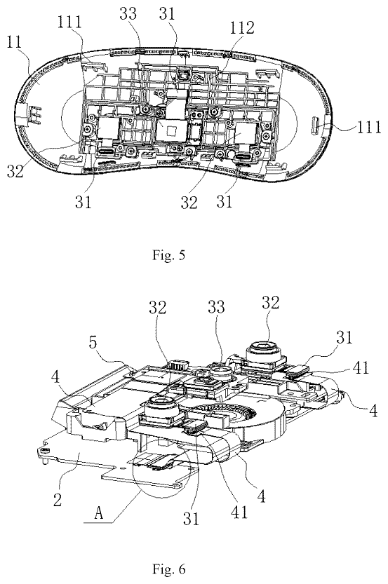

In the present embodiment, the camera component 3 is electrically connected to the main circuit board 2 through the flexible connecting member 4. Exemplarily, the camera component 3 and the flexible connecting member 4 are connected through a plug-in interface, and the main circuit board 2 and the flexible connecting member 4 may also be connected through a plug-in interface. In this embodiment, the above at least two camera components 3 are each connected with a first female connector 31, and one end of the flexible connecting member 4 is provided with a first male connector 41, and the electrical connection between the camera component 3 and the flexible connecting member 4 can be realized by plugging the first female connector 31 and the first male connector 41. As shown in FIG. 5, both of the two RGB camera components 32 and the TOF camera component 33 described above are plugged into the first male connector 41 through the first female connector 31. By providing the first female connector 31 and the first male connector 41, the camera component 3 and the flexible connecting member 4 can be quickly assembled, and the assembly efficiency is improved. It should be pointed out that the flexible connecting member 4 may be connected to the first female connector 31, and the camera component 3 may be connected to the first male connector 41.

In order to better realize the mounting of the camera component 3 and the first female connector 31, a plurality of cross-arranged ribs 112 are provided inside the front housing 11, and the camera component 3 may be placed in the mounting groove formed by the plurality of ribs 112. In addition, a screw hole may be provided on the rib 112, allowing a screw to pass through the through-hole in the camera component 3 and engage with the screw hole via threaded connection to further fix the camera component 3. Similarly, the first female connector 31 may be engaged in the mounting groove formed by the plurality of ribs 112, and may be fixed to the front housing 11 by a screw. By providing a plurality of ribs 112 inside the front housing 11, on the one hand, a foundation for mounting the camera component 3 and the first female connector 31 is provided, and on the other hand, the overall strength of the entire front housing 11 is improved.

As shown in FIG. 3 and FIG. 6, the above-mentioned flexible connecting member 4 may be in a bent state, that is, the flexible connecting member 4 is a flexible member, which can be bent to change its shape, so that the flexible connecting member 4 can be adapted to mounting spaces of different shapes and sizes.

Optionally, the flexible connecting member 4 to which one of the RGB camera components 32 is connected and the flexible connecting member 4 to which the TOF camera component 33 is connected are stacked and insulated from each other. That is, as shown in FIG. 6, the flexible connecting member 4 to which the RGB camera component 32 on the left side is connected and the flexible connecting member 4 to which the TOF camera component 33 is connected are provided at intervals, and the projections on the horizontal plane coincide. Furthermore, the same mounting space can be effectively utilized by the stacked arrangement mode, and the flexible connecting member 4 located below (i.e., the flexible connecting member 4 connected with the TOF camera component 33 in FIG. 5) is just placed on the inner side of the flexible connecting member 4 (i.e., the flexible connecting member 4 connected by the RGB camera component 32 in FIG. 5) located above, making full use of the space on the inner side of the flexible connecting member 4 located above. Thus, within the same mounting space, at least two flexible connecting members 4 can be mounted, effectively saving the space size, and also making the volume of the whole head-mounted display device machine smaller. Of course, it should be understood that for the head-mounted display device disclosed herein, according to the number of camera components 3 and the size and shape of the mounting space, the connecting members 4 connected to a plurality of camera components 3 may be arranged and mounted in a stacked manner to achieve a better spatial structure.

In this embodiment, the flexible connecting member 4 connected to the RGB camera component 32 located on the left is U-shaped bent, and a part of the flexible connecting member 4 connected to the TOF camera component 33 is also U-shaped bent, and is located in the U-shaped internal space of the flexible connecting member 4 connected to the RGB camera component 32. Another end of the flexible connecting member 4 to which the TOF camera component 33 is connected is placed above the main circuit board 2 in a plate-like structure so as to be able to extend to connect the TOF camera component 33. It should be noted that, according to the shape of the mounting space, the flexible connecting member 4 to which the RGB camera component 32 on the left side is connected and the flexible connecting member 4 to which the TOF camera component 33 is connected may be bent a plurality of times as necessary, and may not be bent in a U-shape at this time.

The flexible connecting member 4 to which the RGB camera component 32 on the right side is connected may also have a U-shaped structure, and of course, it may be bent a plurality of times as necessary.

The head-mounted display device according to the embodiment of the present disclosure includes a plurality of camera components, and the flexible connecting members connected by at least two camera components in the plurality of camera components are insulated and stacked, and the same mounting space can be effectively utilized by the stacked arrangement mode, and the flexible connecting member located below is just placed on the inner side of the flexible connecting member located above, and the space on the inner side of the flexible connecting member located above is fully utilized. Thus, within the same mounting space, at least two flexible connecting members 4 can be mounted, effectively saving the space size, making the volume of the whole head-mounted display device machine smaller, and improving the user experience. Moreover, the flexible connecting member can be bent, so that the flexible connecting member can be applied to the situation where the mounting space is small and irregular, and the assembly is easier and more convenient.

For example, as shown in FIG. 3 or FIG. 6, the flexible connecting member 4 connected to the TOF camera component 33 is also connected with an indicator light 5, which is provided in the middle of the front housing 11, and can play a prompt role when taking a picture or recording a video. The indicator light 5 is connected in series to the circuit of the flexible connecting member 4, it is not necessary to add additional connection lines to realize the circuit conduction of the indicator light 5, and the integration of the indicator light 5 on the flexible connecting member 4 is realized. On the one hand, the production cost is reduced (that is, the additional connection lines are reduced); on the other hand, the assembly process is simplified and the assembly efficiency is improved.

In the embodiment of the present disclosure, for example, the above-described flexible connecting member 4 is an FPC flexible board (i.e., a flexible circuit board), which has the characteristics of free bending, folding, winding, small volume, thinning, random movement and contraction, and the like, and can better meet the requirements for mounting space utilization.

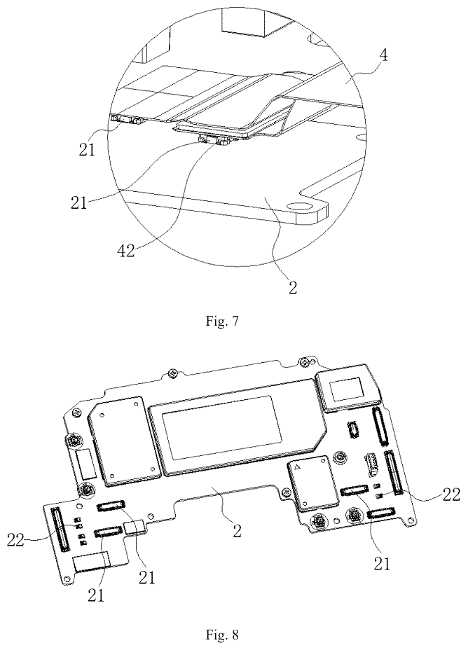

The main circuit board 2 of the present disclosure is mounted in the middle housing 12, and a mounting plate (e.g., a magnesium alloy plate) may be provided in the middle housing 12, and the main circuit board 2 may be fixed to the mounting plate. The main circuit board 2 is a PCB board or an FPC board, as shown in FIG. 7 and FIG. 8, a second female connector 21 is provided on the main circuit board 2, correspondingly, a second male connector 42 is provided at the end of another end of the flexible connecting member 4 (that is, the end not connected to the camera component 3), and the second male connector 42 is plugged into the second female connector 21 to realize the electrical connection between the flexible connecting member 4 and the main circuit board 2, and finally realize the purpose of electrically connecting the camera component 3 to the main circuit board 2 through the flexible connecting member 4. In the embodiment of the present disclosure, considering the stacked arrangement between the flexible connecting member 4 connected to the RGB camera component 32 located on the left and the flexible connecting member 4 connected to the TOF camera component 33, in order to better adapt to the arrangement structure, two second female connectors 21 are provided on the left side of the main circuit board 2, and the two second female connectors 21 are respectively connected to the flexible connecting member 4 connected to the RGB camera component 32 on the left and the flexible connecting member 4 connected to the TOF camera component 33. A second female connector 21 is provided on the right side of the main circuit board 2 to connect the flexible connecting member 4 to which the right-side RGB camera component 32 is connected. It should be noted that it is also possible that the flexible connecting member 4 is connected to the second female connector 21 and the main circuit board 2 is connected to the second male connector 42.

In the embodiment of the present disclosure, when assembling the head-mounted display device, the RGB camera component 32 and the TOF camera component 33 are first mounted on the front housing 11, and the first female connector 31 is connected to the RGB camera component 32 and the TOF camera component 33, and is fixed to the front housing 11.

Subsequently, the main circuit board 2 is mounted in the middle housing 12, and the second female connector 21 is mounted on the main circuit board 2.

Thereafter, the first male connector 41 of the flexible connecting member 4 is plugged into the first female connector 31 of the camera component 3 to realize the electrical connection between the flexible connecting member 4 and the camera component 3. Then, the second male connector 42 of the flexible connecting member 4 is inserted into the second female connector 21 connected to the main circuit board 2, and the flexible connecting member 4 is stacked and bent (of course, the flexible connecting member 4 may be connected to the main circuit board 2 first, and then the flexible connecting member 4 may be connected to the camera component 3).

Subsequently, the front housing 11 is rotationally connected to the middle housing 12 and rotationally snapped onto the middle housing 12, thus completing the entire assembly process.

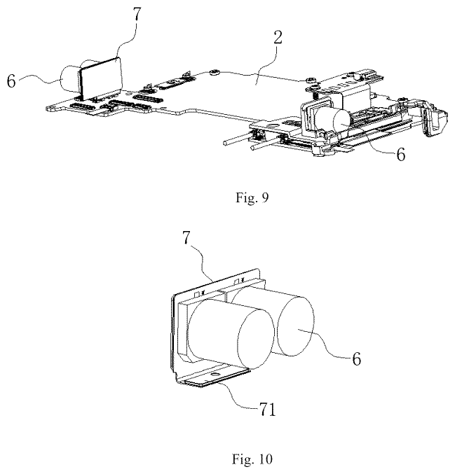

Considering that the head-mounted display device generally has a capacitor on the main circuit board 2, which is used to achieve voltage stabilization for the display screen of the head-mounted display device, and the capacitor is usually mounted on the main circuit board 2 in a manner in which its central axis is perpendicular to the main circuit board 2, because the length of the capacitor along the central axis direction is large, it is inevitable that a sufficient space inside the housing 1 is required to accommodate the capacitor, and thus the volume of the head-mounted display device becomes large. In order to solve the technical problem, referring to FIG. 9 and FIG. 10, the head-mounted display device of the present embodiment further includes a display screen and a capacitor 6, the capacitor 6 is electrically connected to the main circuit board 2 in a manner in which its central axis is parallel to the main circuit board 2, and the capacitor 6 is connected to the display screen through the main circuit board 2 to realize voltage stabilization for the display screen. Because the central axis of the capacitor 6 is parallel to the main circuit board 2, the space required for mounting the capacitor 6 can be reduced, thereby reducing the volume of the head-mounted display device.

Specifically, a first FPC flexible board 7 is added on the original basis, the first FPC flexible board 7 is provided perpendicular to the main circuit board 2, and the length of the first FPC flexible board 7 in the direction perpendicular to the main circuit board 2 is smaller than the length of the capacitor 6 in the direction along the central axis thereof, the capacitor 6 is mounted on the first FPC flexible board 7 and electrically connected to the first FPC flexible board 7; correspondingly, a set of elastic pieces 22 is provided on the main circuit board 2, and the set of elastic pieces 22 can be fixedly connected to the first FPC flexible board 7 to realize the electrical connection between the capacitor 6 and the main circuit board 2.

In the embodiment of the present disclosure, the first FPC flexible plate 7 has an L-shaped structure, and the bottom of the first FPC flexible plate 7 is provided with a connecting portion 71 connected to the elastic piece 22, and the first FPC flexible plate 7 and the elastic piece 22 are fixedly connected by the connecting portion 71. The connecting portion 71 is provided parallel to the main circuit board 2, so as to better fit and fix with the elastic piece 22, and make the connection between the two more stable. Optionally, the number of capacitors 6 is set as needed, for example, two capacitors 6 are fixedly mounted on one of the first FPC flexible boards 7, and one capacitor 6 is mounted on the other first FPC flexible boards 7, which is not specifically limited in the present disclosure.

It should be noted that, in the present disclosure, the relational terms such as “first”, “second”, and the like, are only used to distinguish one entity or operation from another entity or operation, and are not intended to require or imply the existence of any actual relationship or order between these entities or operations. Furthermore, the terms “comprise/comprising”, “include/including”, or any other variations thereof are intended to cover a non-exclusive inclusion such that a process, method, article, or device that includes a list of elements includes not only those elements, but also other elements not expressly listed, or elements inherent to the process, method, article, or device. Without further limitation, an element qualified by the statement “comprises/includes a . . . ” does not exclude the presence of additional identical elements in the process, method, article, or device that includes the element.

The foregoing is merely a specific embodiment of the present disclosure to enable those skilled in the art to understand or implement the present disclosure. Various modifications to these embodiments are apparent to those skilled in the art, and the general principles defined herein may be implemented in other embodiments without departing from the spirit or scope of the present disclosure. Accordingly, the present disclosure is not to be limited to the embodiments described herein, but is to be accorded the widest scope consistent with the principles and novel features disclosed herein.

1. A head-mounted display device, comprising:
a housing;
a main circuit board;
at least two camera components; and
at least two flexible connecting members respectively connected in correspondence with the at least two camera components,
wherein the main circuit board and the at least two camera components are provided in the housing;
each camera component is electrically connected to the main circuit board through a corresponding flexible connecting member;
at least two of the flexible connecting members are stacked and insulated from each other;
the at least two flexible connecting members are in a bent state.

2. The head-mounted display device according to claim 1, wherein the at least two camera components comprise two RGB camera components and one TOF camera component, and a flexible connecting member to which the TOF camera component is connected and a flexible connecting member to which one of the RGB camera components is connected are stacked and insulated from each other.

3. The head-mounted display device according to claim 2, further comprising an indicator light, wherein the indicator light is connected to the flexible connecting member corresponding to the TOF camera component.

4. The head-mounted display device according to claim 1, further comprising a display screen, wherein the main circuit board is electrically connected with a capacitor, a central axis of the capacitor is parallel to the main circuit board, and the capacitor is connected to the display screen through the main circuit board.

5. The head-mounted display device according to claim 2, further comprising a display screen, wherein the main circuit board is electrically connected with a capacitor, a central axis of the capacitor is parallel to the main circuit board, and the capacitor is connected to the display screen through the main circuit board.

6. The head-mounted display device according to claim 3, further comprising a display screen, wherein the main circuit board is electrically connected with a capacitor, a central axis of the capacitor is parallel to the main circuit board, and the capacitor is connected to the display screen through the main circuit board.

7. The head-mounted display device according to claim 4, wherein the main circuit board is provided with an elastic piece, and the capacitor is electrically connected and mounted on a first FPC flexible board, and the first FPC flexible board is fixedly connected to the elastic piece and electrically connected to the main circuit board through the elastic piece.

8. The head-mounted display device according to claim 7, wherein a length of the first FPC flexible board in a direction perpendicular to the main circuit board is smaller than a length of the capacitor in a direction along the central axis of the capacitor.

9. The head-mounted display device according to claim 7, wherein the first FPC flexible plate comprises a connecting portion, the connecting portion is provided parallel to the main circuit board, and the connecting portion is fixedly connected to the elastic piece.

10. The head-mounted display device according to claim 1, wherein the camera component and the flexible connecting member are connected by a plug-in interface; and/or
the main circuit board and the flexible connecting member are connected by the plug-in interface.

11. The head-mounted display device according to claim 2, wherein the camera component and the flexible connecting member are connected by a plug-in interface; and/or
the main circuit board and the flexible connecting member are connected by the plug-in interface.

12. The head-mounted display device according to claim 3, wherein the camera component and the flexible connecting member are connected by a plug-in interface; and/or
the main circuit board and the flexible connecting member are connected by the plug-in interface.

13. The head-mounted display device according to claim 1, wherein the housing comprises a front housing, a middle housing and a rear housing connected in sequence, the camera component is mounted on the front housing, and the main circuit board is mounted on the middle housing.

14. The head-mounted display device according to claim 2, wherein the housing comprises a front housing, a middle housing and a rear housing connected in sequence, the camera component is mounted on the front housing, and the main circuit board is mounted on the middle housing.

15. The head-mounted display device according to claim 3, wherein the housing comprises a front housing, a middle housing and a rear housing connected in sequence, the camera component is mounted on the front housing, and the main circuit board is mounted on the middle housing.

16. The head-mounted display device according to claim 13, wherein one end of the front housing is rotatably connected to the middle housing, and another end of the front housing is snapped into the middle housing.
